(19) United States
(12) Patent Application Publication
(10) Pub. No.: US 2025/0024845 A1
(43) Pub. Date: Jan. 23, 2025

(54) METHODOLOGY FOR EXTENDING THE SHELF LIFE OF PERISHABLE FRUITS THROUGH NON-DESTRUCTIVE, OPTIMUM-THERMAL, AND NON-THERMAL STERILIZATION BASED ON TRACEABLE DATA GENERATED BY AI-BASED ALGORITHMS

(71) Applicants: Meesue Kim, Woodinville, WA (US); Yoo Seung Kim, Bangkok (TH); Nam Soo Kim, Incheon (KR); Min Kyu Kim, Incheon (KR)

(72) Inventors: Meesue Kim, Woodinville, WA (US); Yoo Seung Kim, Bangkok (TH); Nam Soo Kim, Incheon (KR); Min Kyu Kim, Incheon (KR)

(73) Assignee: Meesue Kim, Woodinville, WA (US)

(21) Appl. No.: 18/353,112

(22) Filed: Jul. 17, 2023

(51) Int. Cl. A23L 3/00; A23B 7/005; A23B 7/015; A23B 7/148; A23B 7/157; A23L 3/015; A23L 3/16; A23L 3/26; A23L 3/358; B65B 11/52

(52) U.S. Cl. CPC A23L 3/003; A23B 7/0053; A23B 7/015; A23B 7/148; A23B 7/157; A23L 3/0155; A23L 3/165; A23L 3/26; A23L 3/358; B65B 11/52

(57) ABSTRACT

This invention proposes a method for prolonging the shelf life of perishable fruits and vegetables using a combination of non-destructive thermal and non-thermal sterilization techniques. Leveraging AI-based algorithms, it utilizes traceable data from the entire value and supply chain. This integration allows growers, processors, and traders to collect and analyze traceable data for informed decisions on product quality and safety, effectively minimizing spoilage and quality loss. The environmentally-friendly method uses AI for precise sterilization process control and monitoring, considering factors such as product characteristics and traceability data. This comprehensive approach enhances preservation, improves supply chain management, reduces food waste, and ensures food safety and quality in the fruit & vegetable industry.

### FIELDS

1. Non-Destructive Sterilization Methods: The invention pertains to the field of non-destructive sterilization methods for extending the shelf life of perishable agricultural products especially for the fruit and vegetable. It introduces novel methodology to customize and optimize the conditions of technologies in the fields of food sterilization that eliminate and/or inactivate microbial contaminants without compromising the sensory attributes and nutritional content of the agricultural products.
2. Optimum Thermal and Non-Thermal Sterilization: The invention encompasses the application of optimum thermal and non-thermal sterilization methods to enhance the preservation of perishable agricultural products. It focuses on achieving efficient and effective sterilization while minimizing the use of heat and chemicals, ensuring the integrity and quality of the agricultural products.
3. AI-Based Algorithms and Traceability Systems: The invention integrates advanced AI-based algorithms and traceability systems to collect, analyze, and utilize traceable data generated throughout the value and supply chains. These technologies enable informed decision-making and optimization of the sterilization process based on real-time data analysis.
4. Supply Chain Management and Reduction of Food Waste: The invention addresses the field of supply chain management in the fruit industry and aims to reduce food waste. By implementing the proposed methodology, agricultural products growers, processors, and traders can improve supply chain efficiency, minimize quality loss during transportation and storage, and contribute to a more sustainable and responsible agricultural industry.
5. Product Quality and Safety: The invention focuses on ensuring agricultural product quality and safety throughout the entire value chain. By implementing non-destructive and non-thermal sterilization methods, the invention helps maintain the sensory attributes, nutritional content, and overall quality of the products, providing consumers with safe and high-quality products.
6. Integration of Non-Thermal Technologies: The invention incorporates non-thermal technologies such as ozone bubble water cleansing, HPP, non-thermal cold plasma, vacuum packaging, and Near InfraRed (NIR) spectrometry. These technologies work synergistically to optimize the sterilization process, improve product hygiene, and extend the shelf life of perishable products.
7. Environmental Friendliness: The invention emphasizes the importance of environmentally friendly sterilization methods by minimizing the use of chemicals and heat. The incorporation of non-thermal technologies and optimization through AI-based algorithms contributes to a more sustainable approach to the product preservation and reduces the environmental impact.
   In summary, the invention spans multiple fields, including non-destructive sterilization methods, optimum thermal and non-thermal sterilization, AI-based algorithms, traceability systems, supply chain management, reduction of food waste, product quality and safety, integration of non-thermal technologies, and environmental friendliness. The combination of these elements provides a comprehensive solution for extending the shelf life of perishable agricultural products while maintaining their quality and safety throughout the entire value chain.

### BACKGROUND OF THE INVENTION

Perishable agricultural products (especially fruits and vegetables) are highly susceptible to microbial contamination and degradation, leading to a shortened shelf life and increased food waste. Traditional sterilization methods often involve the use of heat or chemicals, which may negatively impact fruit quality and nutritional value. There is a need for a non-destructive and non-thermal sterilization methodology that extends the shelf life of agricultural products while maintaining their sensory attributes and nutritional content. Additionally, advancements in AI-based algorithms and traceability systems provide an opportunity to optimize the sterilization process based on real-time data analysis. Maintaining the reliable hygiene status of fruits and vegetables after harvesting through the smart application of high-end technologies has been introduced in this application. This novel methodology presented in the invention focuses on highly perishable agricultural products that require special handling to maintain their quality and safety. The current methods for preserving agricultural products post-harvest involve the use of chemical preservatives, such as chlorine and sanitizers, which can leave residues and pose health risks. Moreover, these methods are not effective against all types of microorganisms and can result in a loss of quality and nutritional value. To address the limitations of traditional methods and improve the preservation of products, the present invention provides a novel system and methodology that utilizes a combination of non-thermal technologies and intelligent data management. The following key aspects contribute to the background of this patent application:
1. Hygiene Improvement and Shelf-Life Extension: The patent application aims to improve the hygiene status and extend the shelf life of perishable agricultural products (especially fruit & vegetable) products using novel combinations of non-destructive and non-thermal sterilization methods. By incorporating these methods, the invention overcomes the limitations of traditional sterilization techniques and ensures the quality and safety of the fruits and vegetables.
2. Integration of Technologies and Algorithms: The proposed solution incorporates ozone bubble water cleansing technology, optimum application of the high temperature steam vapor, non-thermal cold plasma vortex magnetic fields technology, High pressure Low Temperature sterilization technology (HPP), customized vacuum packaging technology, Near InfraRed (NIR) spectrometer to monitor the status of targeted products in terms of maturity, and customized AI-based algorithms such as Robotic Process Automation (RPA). This integration optimizes the efficacy of the treatment and generates traceable data throughout the entire value and supply chains. The utilization of AI-based algorithms enables precise control and monitoring of the sterilization process automatically, considering factors such as the characteristics of the targeted product, sterilization parameters, and traceability data.
3. Applicability: The methodology presented in this patent application is applicable to processors, importers, exporters, and relevant government authorities involved in the fruit industry. It offers a comprehensive and optimum solution for improving supply chain management, enhancing the quality of harvested products, and reducing food waste.

By combining multiple layers of optimal thermal and non-thermal technologies, intelligent data management, and the understanding of the susceptibility of targeted products to microbial contamination, the proposed novel methodology provides an efficient and environmentally friendly approach to extend the storage time of perishable agricultural products. It ensures food safety, maintains sensory attributes and nutritional content, and optimizes the sterilization process through AI-based algorithms and real-time data analysis.

### BRIEF SUMMARY OF THE INVENTION

The fields of invention encompass the development of a methodology for extending the shelf life of perishable fruits and vegetables through a combination of non-destructive, optimum thermal, and non-thermal sterilization methods. This methodology utilizes traceable data generated by AI-based algorithms to optimize the sterilization process and enhance product quality and safety. By integrating advanced technologies such as HPP, nano ozone bubble water cleansing, steam vapor sterilization, cold plasma vortex magnetic fields, customized vacuum packaging methodology, and Near InfraRed (NIR) spectrometry, the methodology ensures efficient and environmentally friendly sterilization while maintaining the sensory attributes and nutritional content of the agricultural products. It addresses the challenges of microbial contamination and degradation in the fruit and vegetable industry, offering a comprehensive solution that improves supply chain management, reduces food waste, and supports sustainable agricultural practices. The invention encompasses non-destructive sterilization methods, integration of non-thermal technologies, utilization of AI-based algorithms and traceability systems, and a focus on product quality, safety, and environmental friendliness. Overall, this methodology provides a practical approach to extend the storage time of perishable agricultural products, optimize the sterilization process, and ensure the delivery of safe and high-quality products to consumers.

### BRIEF DESCRIPTION OF THE SEVERAL VIEWS OF THE DRAWING

FIG. 1 provides an overview of the technology integration within the methodology of the invention. Durians, post-harvested, are introduced into a specialized sterilization system. All grades of durians undergo a preliminary cleansing procedure in the water tank, which also serves as a basic sorting process. The cleaned fruits then proceed to the customized nano ozone bubble cleansing process. Subsequently, the fruits are screened using an NIR spectrometer, leading to their categorization into two groups. In the first group, the fruits undergo a non-destructive vapor sterilization process, followed by treatment with cold plasma vortex magnetic fields after cold drying. The fruits from this step are then subjected to special vacuum packaging procedures. These non-destructively sterilized fruits are now ready to be delivered to end-users. It is important to note that all procedures following the NIR spectrometer analysis take place in a controlled CLEAN ROOM atmosphere. The fruits in the second group are intended for cutting and opening. The flesh from the opened fruits undergoes steam vapor sterilization, followed by customized sterilization procedures such as cold plasma vortex magnetic fields and/or HPP treatment immediately after the preliminary vacuum packing process. The processed products from this second group include semi-processed and fully processed products.

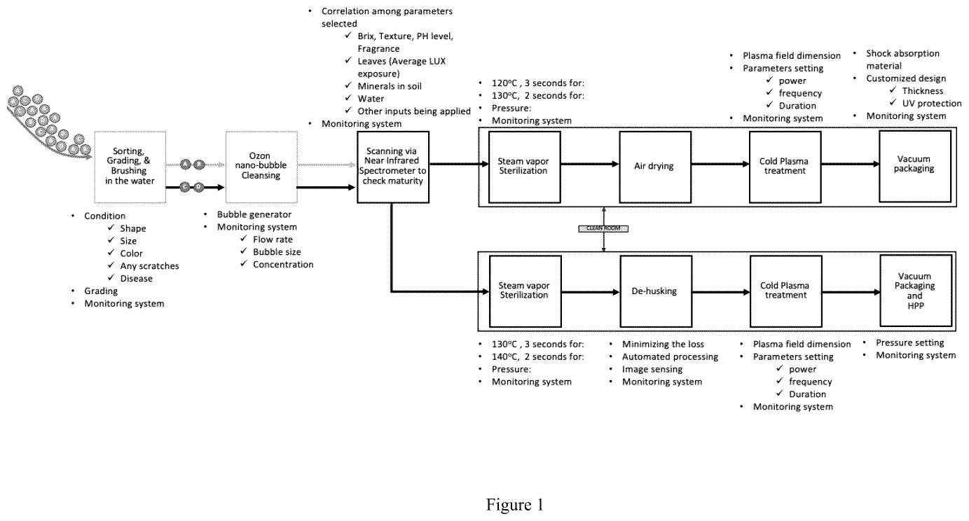

FIG. 2 illustrates the process of nano ozone bubble cleansing procedure. This procedure can be applied all kinds of agricultural products and Drawing 2. Shows how this procedure clean and treat the thick rind fruit, such as durian, jackfruit, and pomelo. The drawing shows a series of steps involved in the fruit sterilization process by ozone bubble. Step 1: Fruit Insertion—The thick rind fruit, represented by a durian in the drawing, is placed on a conveyor belt or any suitable fruit handling mechanism. Step 2: Nano ozone bubble generator, the fruit passes through the nano-ozone bubble cleansing chamber, where the sensors are functioning to monitor the condition of ozone bubble. As the fruit moves through this cleansing chamber, the customized nano ozone bubbles are cleansing the fruits in the chamber in optimum condition. The drawing provides a visual representation of the process, showcasing the movement of the thick rind fruit through the nano-ozone bubble cleansing chamber. This process ensures effective sterilization of the fruit while maintaining its quality and integrity.

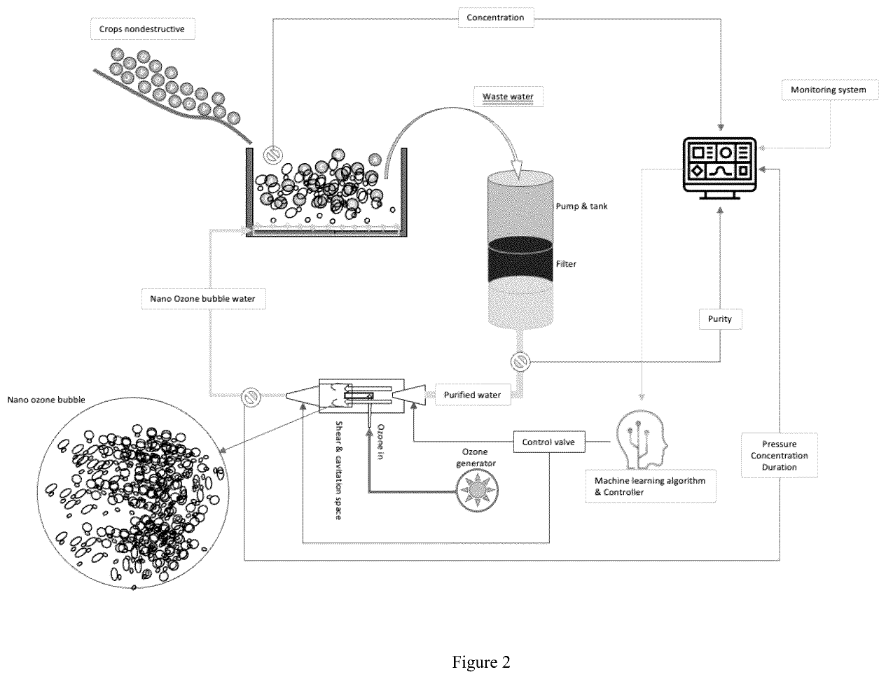

FIG. 3 illustrates the composition of devices and mechanical elements of a non-thermal plasma vortex magnetic fields generator. The generator is a key component in the implementation of the plasma vortex magnetic fields technology for fruit sterilization.

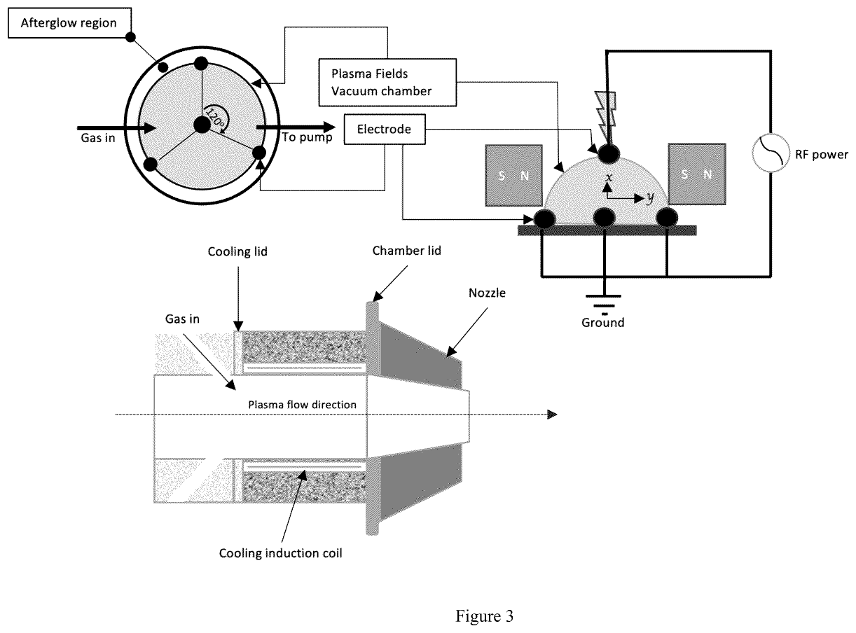

The drawing depicts the various elements and components of the generator:
1. Gas Inlet: The generator is equipped with a gas inlet through which the plasma-forming gas, such as argon or helium, is introduced into the system. The gas inlet ensures a controlled flow of the gas into the generator.
2. Plasma Generation Chamber: The plasma generation chamber is where the plasma-forming gas is excited and transformed into a plasma state. Each grid in the chamber contains 3 electrodes deployed at 120° angle from other two electrodes and other plasma generation components to facilitate the generation of non-thermal plasma.
3. Magnetic Field Generator: The magnetic field generator consists of electromagnets or permanent magnets strategically placed around the plasma generation chamber. It generates a magnetic field that interacts with the plasma, creating a vortex-like motion. Without an external magnetic field, the generated plasma contacts with the inner surface of the dielectric tube in x and y directions and flows outward freely in y direction. But, with a strong magnetic field parallel to the direction y, the charged species and power losses perpendicular to the magnetic field are significantly reduced.
4. Cooling System: The generator is equipped with a cooling system to dissipate heat generated during the plasma generation process. This ensures that the generator operates within optimal temperature ranges for efficient and stable performance.

The composition of devices and mechanical elements in the non-thermal plasma vortex magnetic fields generator enables the generation of non-thermal plasma and the creation of a vortex-like magnetic field. This unique combination plays a crucial role in the fruit sterilization process, providing effective microbial inactivation while preserving the quality of the fruits.

### DETAILED DESCRIPTION OF THE INVENTION

This is a list of common microorganisms that are often found on the surface of fruits and vegetables: 1. Escherichia coli, 2. Salmonella, 3. Listeria monocytogenes, 4. Staphylococcus aureus, 5. Bacillus cereus, 6. Pseudomonas aeruginosa, 7. Clostridium perfringens, 8. Campylobacter jejuni, 9. Shigella spp., 10. Enterobacter spp., 11. Yersinia enterocolitica, 12. Vibrio cholerae, 13. Aspergillus spp., 14. Penicillium spp., 15. Alternaria spp., etc. To deal with microorganisms in the agricultural product, especially the fruit & vegetable, the technologies and methodologies that this invention hired will kill or inactivate microorganisms as follows:
1. 170+α degree Celsius steam vapor: While it's challenging to provide an exhaustive list of microorganisms that can be killed or inactivated by high temperature steam vapor exposure at a specific temperature and duration, this application provides you with a list of common microorganisms that are often found on the surface of the fruit and vegetable: 1. Escherichia coli, 2. Salmonella, 3. Listeria monocytogenes, 4. Staphylococcus aureus, 5. Bacillus cereus, 6. Pseudomonas aeruginosa, 7. Clostridium perfringens, 8. Campylobacter jejuni, 9. Shigella spp., 10. Enterobacter spp., 11. Yersinia enterocolitica, 12. Vibrio cholerae, 13. Aspergillus spp., 14. Penicillium spp., 15. Alternaria spp. The efficacy of steam vapor exposure in killing and/or inactivating these microorganisms may vary depending on various factors such as the specific strain, the surface characteristics of the fruits and vegetables, and the conditions of the exposure. This treatment works effectively not only terminating microbial contamination but also removing chemical residues left from the surface of the fruit and vegetable. One of AI algorithm-based methodologies, such as machine learning and deep learning, is hired to set the conditions to all parameters being utilized for each strain of the fruit & vegetable.
2. Nano ozone bubble cleansing: Also known as micro-ozone bubble washing, is an effective method for killing or inactivating various microorganisms on the surface of the fruit and vegetable and it is known that this sterilization process even eliminates Clostridium botulinum under certain conditions. While it's difficult to provide an exhaustive list of microorganisms that can be targeted, here are some common microorganisms that can be killed or inactivated by ozone bubble cleansing: 1. Escherichia coli, 2. Salmonella, 3. Listeria monocytogenes, 4. Staphylococcus aureus, 5. Bacillus cereus, 6. Pseudomonas aeruginosa, 7. Campylobacter Jejuni, 8. Shigella spp., 9. Enterobacter spp., 10. Yersinia enterocolitica, 11. Vibrio cholerae, 12. Aspergillus spp., 13. Penicillium spp., 14. Alternaria spp. Ozone bubble cleansing technique utilizes ozone, a powerful oxidizing agent, to eliminate microorganisms by damaging their cellular structures. Ozone has broad-spectrum antimicrobial activity and can effectively kill bacteria, viruses, fungi, and other pathogens on the surface of fruits and vegetables. It's important to note that the specific efficacy of ozone bubble cleansing can vary depending on factors such as ozone concentration, contact time, temperature, and the type of microorganism present. RPA is applied to this procedure too.
3. Cold plasma vortex magnetic field treatment: It is a novel technology that combines the use of cold plasma and magnetic fields to kill or inactivate microorganisms on the surface of the fruit and vegetable. While the specific microorganisms that can be targeted by this treatment may vary, here are some common microorganisms that have been shown to be susceptible to cold plasma and magnetic field treatments: 1. Escherichia coli, 2. Salmonella, 3. Listeria monocytogenes, 4. Staphylococcus aureus, 5. Bacillus cereus, 6. Pseudomonas aeruginosa, 7. Campylobacter jejuni, 8. Shigella spp., 9. Enterobacter spp., 10. Yersinia enterocolitica, 11. Vibrio cholerae, 12. Aspergillus spp., 13. Penicillium spp., 14. Alternaria spp. The cold plasma vortex magnetic field treatment generates a unique combination of cold plasma and magnetic fields that can effectively destroy or disrupt the cellular structures of microorganisms, leading to their inactivation or death. This technology offers a non-thermal approach for microbial control on the surface of the fruit and vegetable. It's important to note that the specific efficacy of cold plasma vortex magnetic field treatment may vary depending on factors such as treatment duration, plasma parameters, magnetic field strength, and the characteristics of the targeted microorganisms. RPA is applied for this treatment too.
4. High-pressure processing (HPP): It is a technology that utilizes high pressure to inactivate microorganisms and enzymes in various food products, including the fruit and vegetable based processed products. While the specific microorganisms that can be targeted and inactivated by HPP may vary, here are some common microorganisms that have been shown to be susceptible to HPP treatment on the surface of fruits and vegetables: 1. Escherichia coli, 2. Salmonella spp., 3. Listeria monocytogenes, 4. Staphylococcus aureus, 5. Bacillus cereus, 6. Campylobacter jejuni, 7. Shigella spp., 8. Pseudomonas spp., 9. Clostridium botulinum, 10. Vibrio spp., 11. Yersinia enterocolitica, 12. Enterococcus faecium, 13. Aspergillus spp., 14. Penicillium spp., 15. Alternaria spp. HPP treatment applies high hydrostatic pressure to the food product, which can disrupt the cellular structures of microorganisms, leading to their inactivation or death. The effectiveness of HPP treatment depends on several factors, including the pressure level, treatment time, temperature, and the specific characteristics of the targeted microorganisms. It's important to note that while HPP treatment can significantly reduce microbial populations, it may not completely eliminate all microorganisms. To secure proper handling, storage, and hygiene practices followed to ensure food safety, the methodology of machine learning is applied to this treatment too.
5. Near Infrared (NIR) Spectrometer: Employing NIR spectrometry to analyze the quality and composition of the fruits and vegetables. This non-destructive technique provides valuable insights into sugar content, acidity, ripeness, and the maturity status of the produce. This invention includes the use of NIR spectrometer monitoring system to assess the nutrient value and maturity of products in a non-destructive manner. This advanced sensor emits NIR radiation and measures the reflectance or transmission of fruit samples at different wavelengths. The following key points summarize the benefits of using NIR spectrometer for non-destructive monitoring:
   a) Non-destructive: NIR spectrometer allows for testing without damaging the agricultural products, reducing waste and preserving product quality.
   b) Real-time monitoring: The NIR spectrometer provides real-time data on product status, including texture, brix, and pH. This ensures optimal timing for packaging to maintain quality and freshness.
   c) Improved accuracy: NIR spectrometer offers precise measurements of product status, optimizing the vacuum packaging process and minimizing the risk of spoilage or loss of quality.
   d) Customization: NIR spectrometer can be tailored to specific species of the product and environments, ensuring effective monitoring across different contexts and maintaining the quality of the product.

By utilizing NIR spectrometer monitoring system, the quality and safety of tropical fruits and vegetables can be enhanced. The non-destructive nature, real-time monitoring, improved accuracy, and customization capabilities of the NIR spectrometer contribute to optimizing the vacuum packaging process and ensuring the preservation of fruit quality throughout storage and transport.

This invention introduces a novel methodology that utilizes Artificial Intelligence algorithm applied logistic system to set up a specific customized optimum combination of sterilization related technologies to a targeted agricultural product that can be applied to all kinds of agricultural products, especially for the fruit and vegetable. A specific customized and optimized methodology to fit it to the targeted products is selected from three types of composition and all kinds of fruits & vegetables can be treated by one of these combinations.
1. Cold Plasma Vortex Magnetic Fields+Nano Ozone Bubble Cleansing: Cold plasma vortex magnetic fields can be combined with nano ozone bubble cleansing to achieve microbial control. Cold plasma vortex magnetic fields generate plasma that can destroy microorganisms, including C. botulinum, while nano ozone bubble cleansing utilizing ozone-infused water provides an additional antimicrobial effect. This combination can offer a synergistic approach for effective pathogen reduction.
2. Steam Vapor+HPP+Cold Plasma Vortex Magnetic Fields+Nano Ozone Bubble Cleansing: A comprehensive combination of multiple techniques can be used to maximize microbial control. Steam vapor treatment can be followed by High-pressure processing (HPP) to further inactivate microorganisms. Cold plasma vortex magnetic fields can be applied to disrupt microbial cells, and nano ozone bubble cleansing can provide additional antimicrobial action. This multi-step approach offers a holistic strategy to ensure the safety of fruits and vegetables.
3. Steam Vapor+Cold Plasma Vortex Magnetic Fields+HPP: Steam vapor treatment can be combined with cold plasma vortex magnetic fields and High-pressure processing (HPP) for effective microbial reduction. Steam vapor kills or inactivates microorganisms, while cold plasma vortex magnetic fields disrupt microbial cells. HPP provides additional assurance by subjecting the produce to high pressure. This combination can enhance the efficacy of pathogen control on the surface of fruits and vegetables.

By combining these optimized methodologies, including NIR spectrometer monitoring to assess fruit maturity, this invention offers a comprehensive approach to preserve the quality, extend the shelf life, and ensure the safety of agricultural products, especially fruits and vegetables. The utilization of advanced technologies and data-driven approaches contributes to the effective control of microorganisms, including Clostridium botulinum, and promotes the overall integrity of the supply chain for these perishable commodities.

As an example, the procedures of treating specially selected fruit, THE DURIAN, as one of hard-shell fruits under this invention are as follows:
1. For hard-shell fruits such as durian,
   a) Ozone nano-bubble cleansing treatment is a powerful disinfectant that can significantly reduce the microbial load on the surface of fruits compared to conventional washing methods. Ozone treatment can remove foodborne pathogens such as Escherichia coli and Salmonella from the surface of fruits, making them safer for consumption. Ozone treatment can extend the shelf life of fruits by inhibiting the growth of microorganisms that cause decay. The recommended duration of ozone treatment may vary depending on the type of fruit being treated, with some fruits requiring longer durations of exposure to achieve optimal disinfection. Ozonated water has been found to be effective in reducing microbial loads especially in fresh-cut fruits and vegetables while maintaining their quality. All fruits are subjected to ozonated water treatment, which involves exposing the fruits to water that has been infused with ozone gas. The ozonated water treatment in this invention can reduce the microbial load residing in the surface of the fruits, and can also enhance their color, texture, and aroma. This invention applies the nano ozone bubbles to reach all corners & sides of the surface of the fruit and remove any microbial contaminants present, resulting in a cleaner and safer fruit. The drawing 2. shows a control system to monitor and adjust the parameters of the nano bubble generator, such as flow rate, bubble size, and concentration, to optimize the cleaning efficacy and minimize damage to the fruit. The optimal parameters of the ozonated nano bubble water treatment, such as ozone concentration, exposure time, and temperature, are determined using response surface methodology and other optimization techniques. In the proposed methodology for fruit treatment, ozonated nano bubble water is used as a cleansing method for durian with specific conditions. The treatment involves submerging the fruit in water with a concentration of ozone in the range of 0.15-2.10 mg/L for 180 seconds. This ozone bubble water cleansing has shown significant reduction in microbial load on fruit surfaces compared to conventional washing methods. Several scientific studies provide evidence of the effectiveness of ozone treatment on tropical fruits:
      i. Reduction in microbial load: Ozone treatment reduces microbial counts on fruit surfaces. For example, a study published in the Journal of Food Science and Technology (2019) showed a reduction of up to 1.8 log CFU/g in total aerobic microbial count on papaya fruit surfaces compared to untreated fruit. Conventional washing methods typically achieve a reduction of 0.5-1 log CFU/g.
      ii. Removal of pathogens: Ozone treatment effectively removes foodborne pathogens from fruit surfaces. In a study published in the Journal of Food Protection (2012), ozone treatment reduced the population of Salmonella on mangoes by up to 2.8 log CFU/g. Conventional washing methods may not be as effective in eliminating pathogens.
      iii. Extended shelf life: Ozone bubble water cleansing can extend the shelf life of fruits compared to conventional methods. A study published in the Journal of Food Science and Technology (2015) demonstrated an extension of up to 5 days in the shelf life of guava fruit treated with ozone compared to untreated fruit.
      iv. Improved sensory quality: Ozone treatment enhances the sensory quality of fruits by reducing decay and maintaining freshness. An International Journal of Food Science and Technology study (2016) revealed that ozone treatment improved the appearance, color, and flavor of mangoes compared to untreated fruit.
   These findings highlight the benefits of ozone bubble water cleansing, including microbial load reduction, pathogen removal, extended shelf life, and improved sensory quality. The treatment contributes to enhanced food safety and quality for consumers. It is important to note that the specific conditions for ozone treatment may vary depending on the fruit type, including ozone concentration, exposure time, and temperature. Additional studies have confirmed the efficacy of ozone bubble water cleansing especially for tropical fruits, including rambutan, papaya, and durian. These studies further support the effectiveness of ozone treatment in reducing microbial growth and extending the shelf life of tropical fruits.
   b) A 170-degree Celsius steam vapor with the pressure of the steam vapor between 0.75 MPa and 0.80 MPa (enthalpy (KJ/kg): 719.1hf, 2049hfg. 2768hg) is applied for 0.5 to maximum 2.5 seconds depends on the thickness of the targeted product to sterilize the surface layer of the product (fresh durian) while keeping the meat of the fruit safe from the heat. The data collected from this methodology are applicable to processors, importers, exporters, and relevant government authorities, and can minimize the time consumed during the inspection of the products/commodities and the valuation and validation of trading documents. To minimize the cost incurred during the period of machine learning for this concern, an algorithm will be set up to structure large amounts of datasets to build up our own big data. Best practices for data preprocessing will be followed, including handling missing values, normalization, and splitting the data into training and validation sets. Machine learning is a powerful tool to optimize the parameters for steam vapor treatment of fruits, including the temperature of the steam vapor, the duration of exposure, and the reduction in microbial load. Here are some benefits of using machine learning for parameter optimization:
      i. Increased efficiency: Machine learning algorithms can quickly analyze large amounts of data and identify correlations between parameters and outcomes. This can help identify the optimal treatment conditions more efficiently than manual trial and error methods.
      ii. Improved accuracy: Machine learning algorithms can take into account a wide range of variables that may affect the efficacy of steam vapor treatment, including fruit species, temperature, and exposure time. This can result in more accurate predictions of treatment efficacy compared to traditional statistical methods.
      iii. Customization: Machine learning algorithms can be customized to optimize treatment conditions for specific fruit species and environments. This can help ensure that the treatment is effective across different contexts and that fruit quality is maintained.
      iv. Prediction of outcomes: Machine learning algorithms can also be used to predict the outcomes of different treatment conditions before they are tested experimentally. This can help reduce the need for costly and time-consuming experiments and can also help identify the most promising treatment conditions to be tested in the lab.
   Overall, using machine learning to optimize parameters for steam vapor treatment of fruits can improve efficiency, accuracy, customization, and prediction of outcomes. This can lead to more effective and efficient treatment of fruits, with potential benefits for food safety and quality.
   c) NIR Spectrometer: As an additional aspect of the invention, advanced sensors, specifically NIR spectrometers, are employed to monitor the quality and safety of tropical fruits and vegetables. These spectrometers emit NIR radiation and measure the reflectance or transmission of fruit samples at different wavelengths, providing valuable insights into the maturity and ripeness of durian fruit. Extensive research has been conducted on the application of NIR spectrometry to assess the maturity and ripeness of various fruits, including durian. Previous experiments involved the collection of durian fruit samples at different stages of maturity, spanning from immaturity to full ripeness. These samples were subjected to scanning using NIR spectrometers, encompassing both short-wavelength NIR (SWNIR) ranging from 350 to 1100 nm and long-wavelength NIR (LWNIR) ranging from 750 to 1850 nm. Supervised machine learning algorithms, including RPA and K-Nearest neighbors (KNN), were utilized to develop classification models for accurately assessing the maturity stages of durian fruit. These models effectively utilized the obtained NIR spectra to classify the maturity stages with precision.
      a. Non-destructive: NIR spectrometer is a non-destructive method, which means that it does not damage the fruit during testing. This can help reduce waste and preserve the quality of the fruit.
      b. Real-time monitoring: NIR spectrometer can provide real-time data on the status of the meat, including texture, brix, and pH. This can help ensure that the fruit is packaged at the optimal time to preserve quality and freshness.
      c. Improved accuracy: NIR spectrometer can provide accurate and precise measurements of the status of the meat. This can help optimize the vacuum packaging process and reduce the risk of spoilage or loss of quality.
      d. Customization: NIR spectrometer can be customized to optimize monitoring conditions for specific fruit species and environments. This can help ensure that the monitoring is effective across different contexts and that fruit quality is maintained.
   In summary, using NIR spectrometer to monitor the status of meat in non-destructive condition prior to vacuum packaging can provide several benefits, including non-destructive testing, real-time monitoring, improved accuracy, and customization. This can help optimize the vacuum packaging process and ensure the quality and safety of the fruit. NIR sensors can be used to non-destructively monitor the quality of the fruit, including its texture, brix, and pH. This data can be analyzed to optimize the storage and transport conditions for the fruit, reducing the risk of spoilage and loss of quality.
   d) Non-thermal plasma vortex magnetic fields: The present invention relates to a method and apparatus for sterilizing fruits and vegetables using non-thermal plasma vortex magnetic fields, specifically employing corona discharges (CD). CD is identified as a luminous glow localized in space near sharp points, edges, or thin wires in a highly non-uniform electric field. An asymmetric electrode pair characterizes this discharge type, such as a point and a plane formed when the electric field exceeds the breakdown threshold in a limited spatial region. Drawing 3. shows elements of the cold plasma vortex magnetic fields generation system hired in this invention for the purpose of sterilization of foods. The high electric field near the electrode exceeds the gas breakdown strength, creating a weakly ionized plasma. For increasing the applied area of the CD aiming at food application, a multipoint-plate electrode configuration has been gaining prominence due to its capacity to produce a more energetic and dense plasma than dielectric barrier discharge (DBD), creating a diffusive discharge with much more extensive coverage of the sample surface than a pin tip (Scally et al., 2021). In previous studies, Venkataratnam et al. (2020) investigated the efficacy of CD on major peanut allergens (Ara h 1 and Ara h 2) using a large gap (70 mm) multipoint-plate reactor. The high-voltage power supply used to generate the plasma discharge in atmospheric air was set to a discharge voltage of 32 kV, duty cycle at 118 s, discharge frequency of 1 kHz, and a resonant frequency of 52 kHz. This same equipment was employed to study its efficacies for pesticide degradation (chlorpyrifos and carbaryl) on grapes and strawberries using plasma-activated water (PAW). In this case, the power supply was set to 32 kV, 72 μs, 1 kHz, and 55.51 kHz, respectively. The authors observed that the reduction of chlorpyrifos was 79% on grapes and 69% on strawberries, while carbaryl reduction was 86% on grapes and 73% on strawberries (Sarangapani et al., 2020). Most of the literature presents corona plasma (CP) application with a discharge gap between 10 and 30 mm and a discharge voltage of 60-100 kV. However, the multipoint-plate reactor discussed above in the text was set with a larger gap (70 mm) and the lowest discharge voltage (32 kV). This result showed the importance of combining reactor and generator development, studying hard the influence of electrode configuration, material, electrical parameters, among others, for CP application in food processing. The present invention incorporates the unique methodology of utilizing corona discharges (CD) in conjunction with magnetic fields to create a plasma vortex for sterilizing thick rind fruits, optimizing the discharge parameters, and considering the specific characteristics of the fruits to be sterilized. The design concept of the invention includes: a) Corona Discharge (CD): Utilizing CD to create a weakly ionized plasma near sharp points, edges, or thin wires in a highly non-uniform electric field, employing an asymmetric electrode pair. b) Multipoint-Plate Electrode Configuration: Implementing a multipoint-plate electrode configuration to generate a more energetic and dense plasma than dielectric barrier discharge (DBD), resulting in a diffusive discharge with extensive coverage of the sample surface. c) Optimized Discharge Parameters: Determining optimal parameters for efficient sterilization, including discharge voltage, duty cycle, discharge frequency, and resonant frequency. d) Influence of Electrode Configuration and Material: Investigating the influence of electrode configuration, material, and other electrical parameters to optimize the application of corona discharges in food processing. By incorporating the CD methodology and considering the specific characteristics of the fruits, such as their size, shape, texture, and surface characteristics, the present invention provides an innovative approach to achieve efficient and non-destructive sterilization. The combination of corona discharges and magnetic fields in the form of non-thermal plasma vortex magnetic fields offers several advantages in fruit sterilization. The energetic and dense plasma generated by the multipoint-plate electrode configuration allows for extensive coverage of the fruit's surface, ensuring thorough sterilization. The specific discharge parameters, including voltage, duty cycle, and frequencies, are optimized to maximize the effectiveness of the sterilization process. Studies conducted by Venkataratnam et al. (2020) demonstrated the efficacy of CD in reducing major peanut allergens and degrading pesticides on grapes and strawberries. The reduction percentages observed for chlorpyrifos and carbaryl highlight the potential of CD in eliminating contaminants from fruits. The application of corona discharges in food processing requires careful consideration of various factors, including the design of the reactor and generator, electrode configuration, material selection, and electrical parameters. The present invention addresses these aspects and emphasizes the importance of developing a comprehensive approach to effectively apply corona discharges for fruit sterilization. By incorporating the unique methodologies of corona discharges, the multipoint-plate electrode configuration, and magnetic fields, the present invention offers a novel and efficient solution for sterilizing thick rind fruits. The optimized discharge parameters, combined with a thorough understanding of the fruit's characteristics, ensure effective and non-destructive sterilization while maintaining the fruits' quality and integrity. In summary, the present invention utilizes corona discharges, the multipoint-plate electrode configuration, and magnetic fields to achieve efficient and non-destructive sterilization of thick rind fruits. The unique combination of corona discharges, the multipoint-plate electrode configuration, and magnetic fields in the form of non-thermal plasma vortex magnetic fields provides the following advantages for fruit sterilization:
      i. Enhanced microbial inactivation: The energetic and dense plasma generated by corona discharges in the multipoint-plate electrode configuration, combined with the plasma vortex created by magnetic fields, results in improved microbial inactivation compared to traditional sterilization methods. The thorough coverage of the fruit's surface ensures that a high percentage of microbial contaminants are eliminated.
      ii. Improved penetration: The plasma vortex magnetic fields facilitate the penetration of the non-thermal plasma into the fruit tissue, effectively targeting microorganisms in hard-to-reach areas. The combination of corona discharges and magnetic fields allows for a more comprehensive sterilization process.
      iii. Reduced treatment time: The synergy between corona discharges and magnetic fields enables a faster and more efficient sterilization process. The optimized discharge parameters, combined with the controlled plasma vortex motion, reduce the required treatment time while maintaining the effectiveness of microbial inactivation.
      iv. Non-destructive nature: The non-thermal plasma generated by corona discharges, in conjunction with magnetic fields, offers a non-destructive sterilization method for thick rind fruits. The process does not significantly alter the fruits' sensory attributes, nutritional value, or texture, ensuring that the quality and integrity of the fruits are preserved.
   The present invention encompasses the utilization of corona discharges and magnetic fields in a multipoint-plate electrode configuration for efficient and non-destructive sterilization of thick rind fruits. The optimized discharge parameters, careful consideration of the fruit's characteristics, and comprehensive approach to reactor and generator design ensure the successful implementation of the sterilization process. In conclusion, the incorporation of corona discharges, the multipoint-plate electrode configuration, and magnetic fields in non-thermal plasma vortex magnetic fields provides a novel and efficient solution for the sterilization of thick rind fruits while preserving their quality and integrity. The optimized discharge parameters and comprehensive approach to reactor and generator design ensure the successful implementation of the sterilization process. Furthermore, the addition of corona discharges to the multipoint-plate electrode configuration enables the generation of a diffusive discharge with extensive coverage of the fruit's surface, leading to improved microbial inactivation. The present invention also considers the impact on the environment and the overall sustainability of the sterilization process. By utilizing corona discharges and magnetic fields, which require minimal or no chemical additives, the invention offers an environmentally friendly solution for fruit sterilization. It eliminates the need for heat or chemical treatments that may have detrimental effects on the environment and the nutritional value of the fruits. Additionally, the invention addresses the challenges associated with the sterilization of thick rind fruits, such as durian, jackfruit, pomelo, and others. The protective outer layer of these fruits can harbor microbial contaminants, making them more challenging to sterilize without compromising their quality. The utilization of corona discharges in combination with magnetic fields provides an effective and non-destructive solution specifically tailored to address the unique characteristics of thick rind fruits. In summary, the incorporation of corona discharges and magnetic fields in a multipoint-plate electrode configuration provides an innovative and efficient solution for the sterilization of thick rind fruits. The optimized discharge parameters, consideration of environmental sustainability, and tailored approach for the unique characteristics of these fruits set the invention apart from traditional sterilization methods.
   e) Sensors: The system hired for this invention also includes various types of sensors, such as sensors for temperature, humidity, and gas composition, to monitor the environmental conditions for the agricultural products during storage and transportation. Customized AI-algorithms for each procedure are employed to analyze the data collected from the sensors to optimize the treatment conditions and monitor the quality of the product during storage and transportation.
   f) Blockchain-based monitoring systems: Blockchain-based monitoring systems can provide a transparent and tamper-proof record of the entire supply chain, including the hygiene status of the fruit at different stages of transportation and storage. This data can be used to ensure that the fruit is stored and transported under optimal conditions and reduce the risk of contamination or spoilage. Overall, these monitoring systems can provide a cost-effective and efficient way to monitor the hygiene status of perishable tropical fruits post-harvesting in the supply chain. By using sensors and other advanced technologies, these systems can provide real-time data on the environmental conditions and quality of the fruit, allowing growers and producers to make informed decisions about the storage and transportation of the fruit and reducing the risk of spoilage and loss of quality.
   g) Customized vacuum packaging: It is an effective method for preserving the quality and shelf life of non-thermal sterilized tropical fruits. Modified Atmosphere Packaging (MAP) is an advanced vacuum packaging technology that involves modifying the composition of the air inside the package to create an environment that inhibits the growth of microorganisms. High-pressure processing (HPP) is another advanced that can be applied to the products after vacuum packaging technology that uses high pressure to inactivate any microorganisms left still and enzymes in the fruit. Customized vacuum packaging materials can be used for different types of fruits to protect the fruit from damage and preserve the quality of the fruit during transport and storage. It's a good idea to consider different materials for vacuum packaging for each group of fruits based on their characteristics. Here are some potential considerations for vacuum packaging materials for the two groups of fruits you mentioned:
      1) For thin rind fruits:
         1) Barrier films: Barrier films such as polyethylene (PE) and polypropylene (PP) are commonly used for vacuum packaging of fruits. These films are effective in reducing the amount of oxygen inside the package and extending the shelf life of the fruit.
         2) Perforated films: Perforated films can be used for vacuum packaging of fruits that produce ethylene gas, such as bananas and mangoes. The perforations allow the gas to escape and prevent premature ripening of the fruit. For hard-shell fruits:
      2) For thick rind fruits:
         1) Thick barrier films: thick barrier films such as nylon and polyester can be used to vacuum package hard-shell fruits such as durians and jackfruits. These films provide additional protection against punctures or tears from the sharp spikes or shells of the fruit.
         2) Foaming materials: As you mentioned, foaming materials can also be used to cover the spikes of durians to prevent damage to the vacuum packaging material. Foam inserts or cushioning can also be used to protect the fruit from impact during transport or handling. It's important to choose vacuum packaging materials that are safe for food contact and that will not negatively affect the quality or taste of the fruit.

Additionally, the vacuum packaging material should be compatible with the vacuum packaging equipment used to ensure proper sealing and airtightness. Vacuum packaging is an effective method for preserving the quality and shelf life of non-thermal sterilized tropical fruits by reducing the amount of oxygen inside the package. Here are some advanced vacuum packaging technologies that can help keep these fruits safe from microbial contamination:
a) Modified Atmosphere Packaging (MAP): This technology involves modifying the composition of the air inside the package to create an environment that inhibits the growth of microorganisms. The most common modification is to increase the concentration of carbon dioxide and reduce the concentration of oxygen. This technique has been shown to be effective in extending the shelf life of fruits, including those from tropical regions.
b) High-pressure processing (HPP): This technology uses high-pressure to inactivate microorganisms and enzymes in the fruit. The fruit is placed in a flexible package, and then subjected to high pressure (typically 300-600 MPa) for a short period of time (typically a few minutes). HPP has been shown to be effective in extending the shelf life of non-thermal sterilized fruits, including those from tropical regions.
c) Antimicrobial packaging: This technology involves incorporating antimicrobial agents into the packaging to prevent the growth of microorganisms. For example, the packaging may include silver nanoparticles or other natural antimicrobial agents that can inhibit the growth of bacteria and fungi. Antimicrobial packaging can help extend the shelf life of fruits and improve food safety.

In summary, there are several advanced vacuum packaging technologies that can help keep non-thermal sterilized tropical fruits safe from microbial contamination. These include modified atmosphere packaging, high-pressure processing, smart packaging, and antimicrobial packaging. To demonstrate the concept of a novel design of packaging mentioned in this invention, a drawing for a specific product that has unique shape is provided via following chapter. It shows a schematic representation of the customized vacuum packaging for hard-shell fruits, such as durian. The procedure involves placing the fruit inside a vacuum-sealed package that is tailored to fit the unique shape of the fruit, with additional features to protect the fruit during handling and transport. The drawing shows a durian placed inside a specialized package, with foam inserts that cover the spikes of the fruit to prevent them from puncturing the packaging material. The package is then placed inside a vacuum chamber, where the air is removed to create a vacuum seal that helps to preserve the quality and safety of the fruit.
h) Parameters considered to ensure safety of the agricultural products: To ensure the safety of products during the application of plasma and magnetic fields while effectively terminating hazardous microbial agents, it is important to consider the following conditions when operating the composition of devices and mechanical elements:
   1. Distance and Shielding: The distance between the products and the plasma vortex magnetic fields generator should be carefully determined to maintain a safe separation. Additionally, appropriate shielding materials can be used to protect the products from direct exposure to the plasma and magnetic fields.
   2. Containment Chamber: The use of a containment chamber or enclosure can provide an additional layer of protection for the products. This chamber should be designed to prevent the escape of plasma or magnetic fields while allowing the transmission of their sterilizing effects.
   3. Temperature Control: It is important to monitor and control the temperature during the sterilization process to prevent any adverse effects on the products. The cooling system within the generator should be optimized to maintain an appropriate temperature range that minimizes any heat-related damage to the products.
   4. Exposure Time: The duration of exposure to the plasma and magnetic fields should be carefully controlled. Sufficient exposure time is required to ensure effective microbial termination, while avoiding prolonged exposure that may negatively impact the quality or integrity of the products.
   5. Control System: The control system of the generator plays a critical role in maintaining the desired conditions. It should allow for precise regulation of parameters such as gas flow, plasma intensity, and magnetic field strength to ensure optimal sterilization efficacy while minimizing potential risks to the products.

Testing and Validation: Prior to implementation, thorough testing and validation should be conducted to assess the safety and efficacy of the composition of devices and mechanical elements. This can include conducting experiments on various types of fruits to evaluate the impact of the plasma and magnetic fields and ensure that the desired microbial termination is achieved without compromising the quality of products.

In conclusion, the present invention introduces a novel methodology for extending the shelf life of perishable agricultural products through non-destructive and non-thermal sterilization based on traceable data generated by AI-based algorithms. By incorporating non-thermal sterilization techniques and leveraging AI algorithms for data analysis and optimization, the methodology offers a comprehensive solution for improving fruit preservation, supply chain management, and reducing food waste. The optimum combination of non-destructive and non-thermal sterilization techniques, AI-based algorithms, and traceability systems enables precise control, customization, and monitoring of the sterilization process. This methodology ensures the extended shelf life of perishable products while maintaining their quality, nutritional value, and sensory attributes.

With the implementation of the methodology and the accompanying system, agricultural product producers, suppliers, and retailers can enhance the efficiency of their operations, reduce losses due to spoilage, and provide consumers with high-quality and safe products with an extended shelf life.

The AI-based algorithms and data analysis techniques play a crucial role in optimizing the sterilization process by analyzing fruit characteristics, environmental conditions, sterilization parameters, and quality indicators. This data-driven approach enables dynamic adjustments and continuous improvement of the sterilization process, ensuring optimal results for different products varieties and storage conditions. The traceability systems integrated into the methodology provide end-to-end visibility and accountability throughout the supply chain of the products. By collecting and storing data related to the specific characteristics of the products, sterilization parameters, environmental conditions, and quality indicators, the traceability systems enable comprehensive monitoring and facilitate informed decision-making at each stage of the supply chain. In conclusion, the methodology for extending the shelf life of perishable products through non-destructive and non-thermal sterilization, based on traceable data generated by AI-based algorithms, offers a transformative solution to the product preservation and supply chain management. By combining advanced sterilization techniques, AI-driven optimization, and traceability systems, the methodology ensures extended shelf life, improved quality, and reduced waste. This innovation contributes to the sustainable and efficient utilization of perishable products, benefiting both industry stakeholders and consumers.

The invention claimed is:

1. A method that extends the shelf life of perishable agricultural products using optimal thermal and non-thermal sterilization techniques, combined with advanced algorithms for traceable data, selecting the best mix of ozonated nano bubble cleansing, steam vapor cleansing, NIR spectrometer monitoring, cold plasma vortex magnetic fields, high-pressure processing, and customized vacuum packaging technologies specific to each fruit or vegetable species, optimized using machine learning and deep learning algorithms.

2. The method according to claim 1 integrates AI-based algorithms and data analysis to generate real-time traceable data across value and supply chains, specifically applied to a Sterilization Process System (SPS) that includes Ozonated Nano bubble cleansing, Steam vapor cleansing, NIR spectrometer monitoring, Cold plasma vortex magnetic fields, High-Pressure Processing (HPP), and Customized Vacuum Packaging technologies, with the system adjusting sterilization parameters based on analyzed raw data for optimal efficacy and quality maintenance.

3. The method according to claim 1 involves using traceability systems to collect and store data on agricultural crop characteristics, sterilization parameters, and environmental conditions during the Sterilization Process System (SPS) procedure, optimizing sterilization conditions via AI-based algorithms using this data to extend the shelf life of targeted agricultural products, particularly fruits and vegetables, while preserving their quality and sensory attributes.

4. The method according to claim 1 involves careful selection and monitoring of sterilization parameters like pH level, ozone concentration, bubble size, steam vapor temperature, and exposure duration within the Sterilization Process System (SPS), also considering plasma sterilization distance and shielding, clean-room containment, temperature control, and targeted crop timing in each procedure, and implements safety testing and validation processes.

5. The method according to claim 4 involves using AI algorithms to determine the safe distance between products and the plasma vortex magnetic fields generator during the Sterilization Process System (SPS) procedure, and uses suitable shielding materials to prevent direct product exposure to plasma and magnetic fields, providing additional protection.

6. The method according to claim 4 incorporates a containment chamber in the Sterilization Process System (SPS) that uses AI analysis for safeguarding products, ensuring optimal sterilizing effects, temperature control, and mitigating heat-related damage, while an AI-based control system manages exposure time for microbial termination and product integrity, also regulating critical parameters like gas flow, plasma intensity, and magnetic field strength for exceptional sterilization and minimal risk.

7. The method according to claim 4 includes thorough pre-implementation testing and validation on diverse agricultural crops, particularly fruits and vegetables, to evaluate device safety and effectiveness, assess the impact of cold plasma and vortex magnetic fields on microbial termination and product quality, and confirm the composition of devices and mechanical elements meets required standards without compromising product integrity.

8. The method according to claim 1 includes selecting tailored optimum-thermal or non-thermal sterilization techniques, such as ozonated nano-bubble treatment, cold plasma vortex magnetic fields, high-pressure and low-temperature sterilization (HPP), and steam vapor cleansing during the Sterilization Process System (SPS) procedure, ensuring effective microbial control, extended shelf life, and preserved quality and sensory attributes for each targeted species of agricultural product.

9. The method according to claim 2 leverages AI-based algorithms and data analysis techniques for real-time monitoring and dynamic adjustment of sterilization parameters during the Sterilization Process System (SPS) procedure, utilizing traceability systems to collect data related to targeted crops' characteristics, environmental conditions, and quality indicators, ensuring extended shelf life and maintained quality, nutritional value, and sensory attributes of perishable fruits and vegetables.

10. The method according to claim 2 uses AI-based algorithms and data analysis techniques for optimizing sterilization by analyzing parameters such as produce traits, environmental conditions, and sterilization parameters, while integrating AI algorithms and sensors in control and monitoring systems for real-time adjustment during the Sterilization Process System (SPS) procedure, supported by traceability systems for holistic data collection and supply chain monitoring.

11. The method according to claim 3 uses AI-based algorithms to optimize sterilization parameters, analyzing traceable data considering the interplay among produce characteristics, environmental conditions, and sterilization results, to extend the shelf life of perishable fruits and vegetables, maintaining their quality, nutritional value, and sensory attributes throughout storage.

12. The system according to claim 11 implements the a method comprising of tailored optimal thermal and non-thermal sterilization equipment, AI-based algorithms and data analysis tools for real-time traceable data, control and monitoring systems using AI and sensors for continuous parameter adjustment, and traceability systems for comprehensive data management, providing an efficient system for sterilization optimization and agricultural product quality assurance.

13. Building upon claim 12, the system includes communication interfaces for smooth data exchange and integration, as well as specialized non-destructive and non-thermal sterilization equipment, including non-thermal plasma vortex magnetic fields generators, nano-ozone bubble generators, and pulsed light systems, delivering a comprehensive solution for fruit and vegetable sterilization optimization, enabling real-time data sharing and efficient coordination throughout the process.

14. A method that prolongs the shelf life of perishable fruits and vegetables by employing a unique blend of sterilization techniques, including ozonated nano bubble water treatment, machine learning-optimized steam vapor sterilization, and cold plasma vortex magnetic fields, with an integrated specially designed ozonated nano bubble generator for enhanced cavitation, ensuring effective microbial control and quality preservation throughout storage.

15. A method that applies cold plasma vortex magnetic fields, using 120-degree angle electrode configurations, to effectively deactivate microorganisms on non-destructive fruits, vegetables, and processed food products, maintaining their natural moisture content to preserve quality while enhancing microbial control.

16. A method that involves using a specialized foaming material before vacuum packaging fruits and vegetables to safeguard their integrity and freshness by preventing potential damage from sharp rind characteristics, ensuring effective preservation during storage and transportation.

17. A system designed to extend the shelf life of perishable fruits and vegetables that consists of various components, including an ozonated nano bubble generator (as shown in drawing 2) specifically engineered to enhance cavitation in the ozonated nano bubble water treatment, a steam vapor system optimized through machine learning analysis, a Near InfraRed (NIR) spectrometer used to classify crops based on monitored parameters such as nutrient value and maturity, and cold plasma vortex magnetic field technology to effectively control microbial activity.

18. The system according to claim 17 also includes specialized packaging methodologies specifically designed for non-destructive treatment of the fruits and vegetables, safeguarding their quality throughout storage and transportation.

19. The system according to claim 17 that incorporates unique sterilization methodologies such as a specialized ozonated nano bubble generator with redirection parts to enhance cleansing, a steam vapor treatment optimized via machine learning for efficient sterilization, a non-destructive Near InfraRed (NIR) spectrometer for crop classification based on parameters like nutrient value and maturity, customized cold plasma vortex magnetic fields for microbial control, and specialized non-destructive packaging methodologies, all working in concert to enhance microbial control and extend the shelf life of various fruit and vegetable species.

20. A method for assessing fruit composition and quality that involves using a Near Infrared (NIR) spectrometer to emit radiation onto a fruit or vegetable sample, measuring its reflectance or transmission at various wavelengths, and adjusting parameters such as wavelength range, integration time, and sample temperature to enhance measurement accuracy and minimize potential fruit damage.

21. A smart packaging system, designed for agricultural crops sterilization, integrates vacuum packaging with custom materials, Modified Atmosphere Packaging (MAP), AI-optimized High-pressure Low-temperature sterilization (HPP), and antimicrobial packaging with silver nanoparticles post cold plasma vortex magnetic field treatment, ensuring improved safety and extended shelf life of fruits and vegetables.

22. A customized vacuum packaging method for fruits and vegetables, especially hard-shell ones, incorporates AI algorithm-controlled vacuum chamber adjustments and specialized features like foam inserts to prevent packaging damage, thereby optimizing preservation and quality throughout storage and distribution.

23. A system that combines corona discharges and magnetic fields to sterilize fruits and vegetables, utilizing a corona discharge chamber with multipoint-plate electrodes, strategically placed magnetic field generators, adjustable control mechanisms, sensors, monitoring devices, quality assessment mechanisms, optimized electrode configuration and material, and where experimetal trials validate microbial elimination, fruit safety, and assess the impact on nutrition, texture, and sensory attributes for quality preservation, ensuring efficient and safe sterilization of fruits and vegetables.

24. A device that incorporates a specialized nano bubble generator, a machine learning-integrated steam vapor system, a Near InfraRed (NIR) spectrometer, a cold plasma vortex magnetic field apparatus, and a specialized packaging system to extend the shelf life and preserve the quality, nutritional value, and sensory attributes of perishable fruits and vegetables, providing a comprehensive solution for freshness and safety enhancement.

25. A system for preserving and extending the shelf life of agricultural crops, comprising a customized steam vapor system, a Near InfraRed (NIR) spectrometer, a cold plasma vortex magnetic field apparatus, and a specialized packaging system, preserves the quality and extends the shelf life of agricultural crops.

26. The system according to claim 25 utilizes the customized steam vapor system, which optimizes sterilization, the NIR spectrometer enables real-time monitoring and classification, the cold plasma vortex magnetic field apparatus ensures effective microbial control, and the specialized packaging system maintains quality and freshness during storage, providing a comprehensive solution for perishable produce enhancement.

27. A computer-implemented method that optimizes the preservation of perishable fruits and vegetables according to claim 4 by analyzing data from a NIR spectrometer to classify crops, using machine learning to adjust sterilization parameters, monitoring environmental conditions, employing data analytics and predictive modeling for assessing shelf life and spoilage risks, and providing actionable recommendations, thereby enhancing preservation and quality while enabling informed decision-making throughout the supply chain.

28. The computer-implemented system that optimizes the preservation of perishable fruits and vegetables according to claim 27 is comprised of NIR spectrometer analysis, machine learning algorithms, real-time monitoring, data analytics, and predictive modeling, enabling informed decisions and enhancing product quality, shelf life, and waste reduction in the fruit and vegetable industry.

29. The system that optimizes perishable fruit and vegetable preservation according to claim 28 integrates NIR spectrometers for quality assessment, machine learning algorithms for sterilization optimization, real-time environmental monitoring, data analytics for shelf-life estimation, and user-friendly interfaces for informed decision-making throughout the supply chain, leading to enhanced product quality, extended shelf life, waste reduction, and informed decision-making.

30. The comprehensive system that optimizes perishable fruit and vegetable preservation according to claim 29 seamlessly integrates NIR spectrometers into sorting and grading machines for swift and accurate quality assessment, utilizing evolving machine learning algorithms for improved sterilization parameter optimization, enabling real-time monitoring of environmental conditions through wireless sensors and IoT-enabled devices, employing advanced data analytics and predictive modeling tools to forecast shelf life and guide decision-making, and facilitating information sharing and collaboration among stakeholders, resulting in optimized quality, extended shelf life, waste reduction, and enhanced sustainability in the preservation process.
